(19) United States
(12) Patent Application Publication
(10) Pub. No.: US 2005/0083681 A1
(43) Pub. Date: Apr. 21, 2005

(54) Spotlight apparatus with solar power

(76) Inventor: Chih-Lung Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/685,379

(22) Filed: Oct. 16, 2003

(51) Int. Cl. F21L 4/00

(52) U.S. Cl. 362/122; 362/183

(57) ABSTRACT

The invention relates to a spotlight apparatus with solar power, which includes a container. One side of the container is provided a spotlight and a plane composed by many solar plates to store energy and to provide,power for the spotlight at night. Another side of the container can, be provided with plants or any statues, which can be lightened at night to show its special decorative effect.

### BACKGROUND OF THE INVENTION

In some gardens, it is usually provided with plants or statues for decoration. At night, it is necessary to use a spotlight to lighten the decoration to show its figure and to obtain its decorative purpose. Since the spotlight must be provided independently and connected with extra electrical wires, it will be very trouble and inconvenient. At the meantime, the electrical wires exposed outside will break the view of the garden.

Accordingly, the present invention is to provide a spotlight apparatus with solar power, which can be, combined with any decoration as a single object that can overcome the drawback of a prior art. Now with following drawings, it will disclose the characters and effects of the present invention.

### BRIEF DESCRIPTION OF THE DRAWINGS

FIG. 1 is a perspective view showing a spotlight apparatus with solar power combined with an embodiment of decoration according to the present invention.

FIG. 2 is a cross-sectional plan view of FIG. 1.

### DETAILED DESCRIPTION OF THE PREFERRED EMBODIMENT

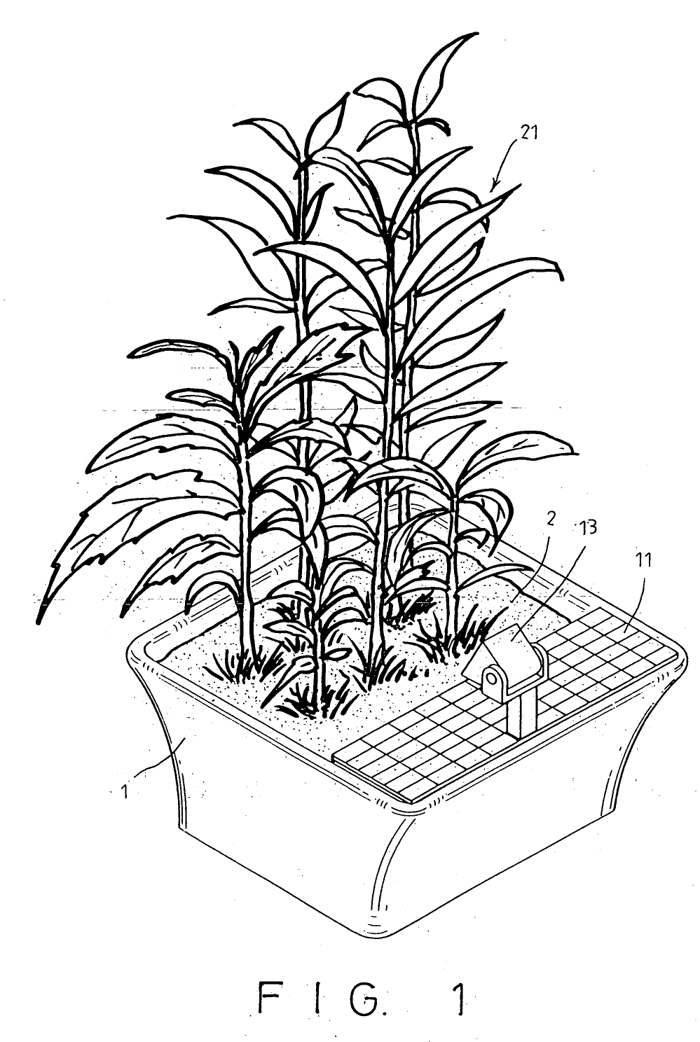

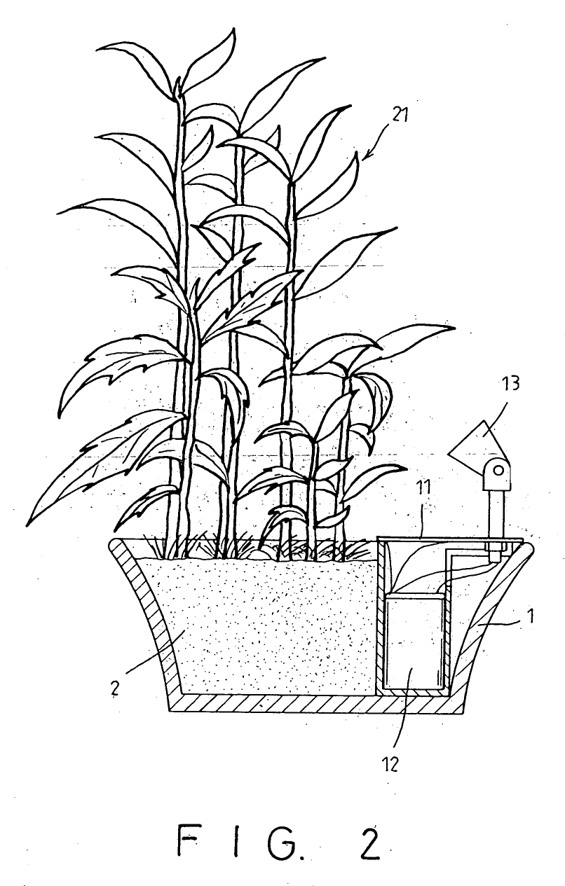

Please referring to FIGS. 1 and 2, it discloses an embodiment of the present invention in applying on a potted plant. The apparatus includes a container (1) being separated into two portions, one of which is provided with a plane consisted by many solar plates (11) and a battery (12) therein. A spotlight (13) in mounted on the plane and connected with the battery (12) by electrical wires. Another portion of the container (1) is provided with earth (2) therein and plants (21) are planted on earth (2).

In daytime, the solar plates (11) can store the solar energy in the battery (12). And at night, the battery (12) can provide the power for spotlight to lighten the plants (21) to obtain the shining decorative effect. Since the apparatus is a single body, it can be placed at any desired position in the garden. It will be useful and effective. Moreover, the extra connecting electrical wires are no more necessary. This is also an obvious improvement and solves the problem of a prior art.

Accordingly, the present invention obtains the predicted purpose. But the above embodiment is only an example disclosed in the description. Any other decoration is possible to provide by this invention. For example, a statue can replace the plants to put on the container. And it can be lightened by the spotlight to show its special decorative effect at light.

1. A spotlight apparatus with solar power including a container being separated into two portions, one of which is provided with a plane being composed by many solar plates and a battery being received therein, and a spotlight being mounted on the plane; another portion of the container being capable of providing with decorations thereon.

2. A spotlight apparatus with solar power as claimed in claim 1, wherein the decoration is plant being planted on earth.

3. A spotlight apparatus with solar power as claimed in claim 1, wherein the decoration is any desired statues.
